(19) United States
(12) Patent Application Publication
(10) Pub. No.: US 2019/0286260 A1
(43) Pub. Date: Sep. 19, 2019

(54) TOUCH PANEL, METHOD FOR MANUFACTURING TOUCH PANEL, AND ELECTRONIC DEVICE

(71) Applicant: SMK Corporation, Tokyo (JP)

(72) Inventor: Tsutomu INOUE, Toyama (JP)

(73) Assignee: SMK Corporation, Tokyo (JP)

(21) Appl. No.: 16/296,142

(22) Filed: Mar. 7, 2019

(30) Foreign Application Priority Data
Mar. 19, 2018 (JP) JP2018-051181

(51) Int. Cl. G06F 3/044

(52) U.S. Cl. CPC G06F 3/044; G06F 2203/04102; G06F 2203/04107; G06F 2203/04103

(57) ABSTRACT

For example, a touch panel is efficiently manufactured. A touch panel includes: a base; a first transparent conductive sensor portion provided on a first major surface of the base; a first wiring portion connected to the first sensor portion and provided on the first major surface; a second transparent conductive sensor portion provided on a second major surface of the base, the second major surface being on a side opposite to the first major surface; and a second wiring portion connected to the second sensor portion and provided on the second major surface, each of the first and second wiring portions includes a plurality of wires partitioned by laser grooves, and the first and second wiring portions are provided respectively in positions that do not overlap with each other in a cross-sectional direction from the first major surface to the second major surface.

### FIELD

The present invention relates to a touch panel, a method for manufacturing a touch panel, and an electronic device.

### BACKGROUND

In recent years, a touch panel (also called a touchscreen) for detecting an operation input on a display element such as a liquid crystal display element, included in, for example, a mobile device, a mobile phone device, or a car navigation device is widespread. A capacitive touch panel is known as one of touch panel systems. The capacitive touch panel generally includes a conductive film provided as a sensor unit on an insulating base, and a wiring portion routed from the conductive film. The capacitive touch panel detects a change in capacitance between an operating body such as an operator's finger or a pen and the sensor unit to detect the location. An output signal from the sensor unit is transmitted to a control IC (Integrated Circuit) via the wiring portion and a flexible printed circuit (FPC (Flexible Printed Circuits)) connected to the wiring portion.

A method for forming the above-mentioned sensor unit of the touch panel by laser etching (a laser patterning method) has been proposed. For example, Patent Literature 1 below describes a method for forming a transmitting (Tx) electrode and a receiving (Rx) electrode, which are made of a transparent conductive layer, on both sides of a glass substrate by laser patterning.

### PRIOR ART DOCUMENT

### Patent Literature

Patent Literature 1: Japanese Patent No. 6211098

### SUMMARY

As described in Patent Literature 1, when a pattern of, for example, a transmitting electrode is formed by laser patterning on the front side of the glass substrate in the method using laser patterning, a laser may penetrate the glass substrate to damage a pattern of, for example, a receiving electrode provided on the back side. Therefore, when laser patterning is performed on each of the front and back sides of the glass substrate, there arises a problem that a laser output (for example, the laser density) needs to be adjusted with high accuracy to avoid damage to a configuration located on the other side. When a configuration other than an electrode, for example, a wiring portion made of metal such as Ag, is formed on both sides of, for example, the glass substrate, using laser patterning, such a problem also arises likewise.

Therefore, one of objects of an aspect of the present invention is to provide a touch panel, a method for manufacturing a touch panel, and an electronic device that can form a predetermined configuration (for example, a wiring portion) on each side of a base without adjusting a laser output by fundamentally avoiding a laser damaging, for example, an electrode located on the other side.

An aspect of the present invention is, for example, a touch panel including: a base; a first transparent conductive sensor portion provided on a first major surface of the base; a first wiring portion connected to the first sensor portion and provided on the first major surface; a second transparent conductive sensor portion provided on a second major surface of the base, the second major surface being on a side opposite to the first major surface; and a second wiring portion connected to the second sensor portion and provided on the second major surface. Each of the first and second wiring portions includes a plurality of wires partitioned by laser grooves, and the first and second wiring portions are provided respectively in positions that do not overlap with each other in a cross-sectional direction from the first major surface to the second major surface.

Moreover, an aspect of the present invention may be an electronic device including the above-mentioned touch panel.

Moreover, an aspect of the present invention is, for example, a method for manufacturing a touch panel including: a first step of forming a first transparent conductive sensor portion on a first major surface of a base, and forming a second transparent conductive sensor portion on a second major surface on a side opposite to the first major surface; a second step of forming a first wiring portion connected to the first sensor portion on the first major surface by laser patterning; and a third step of forming a second wiring portion connected to the second sensor portion on the second major surface by laser patterning. The second and third steps include forming the first and second wiring portions respectively in positions that do not overlap with each other in a cross-sectional direction from the first major surface to the second major surface.

According to an aspect of the present invention, it is possible to form a predetermined configuration (for example, a wiring portion) on each side of a base without adjusting a laser output with high accuracy. The contents of the aspect of the present invention are not interpreted by being limited by effects illustrated by example in the description.

### BRIEF DESCRIPTION OF DRAWINGS

FIG. 1 is an exploded perspective view of a touch panel according to one embodiment.

FIG. 2 is a diagram illustrating a first sensor portion and a first conductive portion, which are provided on a first major surface of the touch panel according to one embodiment.

FIG. 3 is a diagram illustrating a first wiring portion provided on the first major surface of the touch panel according to one embodiment.

FIG. 4 is a partially enlarged view of FIG. 3.

FIG. 5 is a diagram illustrating the first sensor portion, the first conductive portion, the first wiring portion, and the like according to one embodiment in combination.

FIG. 6 is a diagram illustrating a second sensor portion and a second conductive portion, which are provided on a second major surface of the touch panel according to one embodiment.

FIG. 7 is a diagram illustrating a second wiring portion provided on the second major surface of the touch panel according to one embodiment.

FIG. 8 is a partially enlarged view of FIG. 7.

FIG. 9 is a diagram illustrating the second sensor portion, the second conductive portion, the second wiring portion, and the like according to one embodiment in combination.

FIG. 10 is a diagram illustrating a projection of the configuration of the touch panel according to one embodiment onto one side of a base.

FIG. 11A is a cross-sectional view in a case where the touch panel has been cut along line A-A′ in FIG. 10.

FIG. 11B is a cross-sectional view in a case where the touch panel has been cut along line B-B′ in FIG. 10.

FIG. 11C is a cross-sectional view in a case where the touch panel has been cut along line C-C′ in FIG. 10.

FIG. 12 is a diagram for explaining an example of the configuration of a connection portion of the touch panel according to one embodiment.

FIG. 13A is a flowchart illustrating a method for manufacturing a touch panel according to one embodiment.

FIG. 13B is a diagram illustrating configurations formed in the method for manufacturing a touch panel according to one embodiment in chronological order.

FIG. 14 is a diagram for explaining a modification.

### DESCRIPTION OF EMBODIMENTS

An embodiment and the like of an aspect of the present invention are described hereinafter with reference to the drawings. Descriptions are given in the following order:

### 1. Embodiment

### 2. Modification

However, an embodiment and the like illustrated below are illustrations of a configuration for realizing a technical idea of an aspect of the present invention. An aspect of the present invention is not limited to the illustrated configuration. Members illustrated in the claims are not specified to members of the embodiment. Especially, for example, descriptions of the dimensions, materials, shapes, relative placements, and directions such as up, down, left, and right of constituent members described in the embodiment, unless otherwise particularly limited and specified, are not intended to limit the scope of an aspect of the present invention to only them, and are simply explanatory examples. The sizes, positional relationships, and the like of members illustrated in the drawings may be exaggerated to clarify the description. Moreover, in order to prevent the illustrations from becoming complicated, only a part of reference signs may be illustrated, and only a part may be simplified and illustrated. Furthermore, in the following descriptions, the same names and reference signs indicate the same or homogenous members, and their overlapping descriptions are omitted as appropriate. Furthermore, each element configuring an aspect of the present invention may have an aspect where a plurality of elements is configured by the same member and the one member serves as the plurality of elements. Conversely, the function of one member may be shared by a plurality of members to realize the one member.

In the following description, an X-axis, a Y-axis, and a Z-axis indicate a three orthogonal-axis coordinate system. It is assumed that a positive direction of the X-axis is an upward direction, a negative direction of the X-axis is a downward direction, a positive direction of the Y-axis is a right direction, a negative direction of the Y-axis is a left direction, a positive direction of the Z-axis is a frontward direction, and a negative direction of the Z-axis is a depth direction.

### 1. Embodiment

### [Example of Schematic Configuration of Touch Panel]

A touch panel (a touch panel 1) according to one embodiment is described. The touch panel 1 is used as input devices of various electronic devices such as a mobile information terminal device, a mobile phone device, a smartphone, and a vehicle-mounted device. Moreover, in the embodiment, a description is given taking, as an example of the touch panel 1, what is called a capacitive touch panel that has multiple electrodes along an input operation area on an insulating substrate, detects an electrode where capacitance between detection electrodes has been changed due to the approach of an input operating body such as a finger, and detects the input operation position from the position of the electrode.

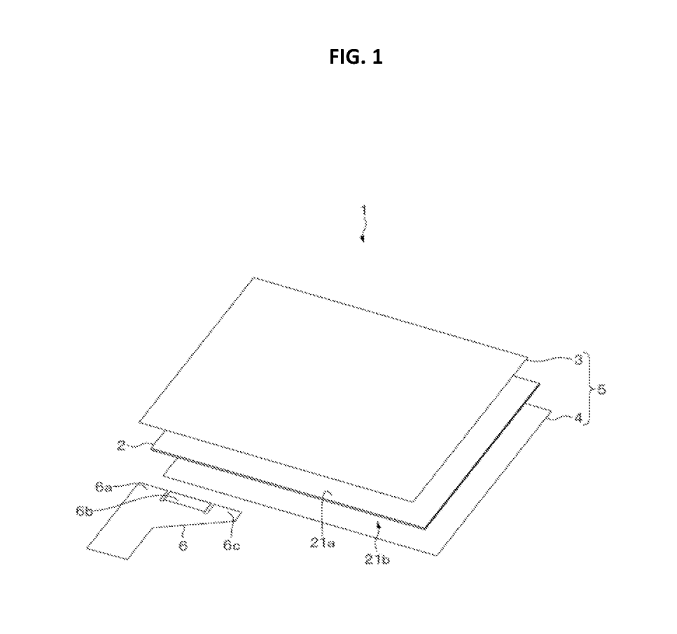

FIG. 1 is an exploded perspective view for explaining an example of the schematic configuration of the touch panel 1. The touch panel 1 includes, for example, a base 2, a first sensor portion 3 provided on a first major surface 21a being one of major surfaces of the base 2, and a second sensor portion 4 provided on a second major surface 21b of the base 2, the second major surface 21b being on a side opposite to the first major surface 21a. The first sensor portion 3 and the second sensor portion 4 form a sensor unit 5 being a sensor unit of the touch panel 1.

An FPC 6 is connected by, for example, thermal compression to each of a predetermined place of the first major surface 21a and predetermined places of the second major surface 21b. A distal end of the FPC 6 is divided by, for example, notches into three distal end portions (distal end portions 6a, 6b, and 6c). For example, the distal end portion 6b is connected to the first major surface 21a, and the distal end portions 6a and 6c are connected to the second major surface 21b. The FPC 6 is connected to the first sensor portion 3 via a first wiring portion described below, and is connected to the second sensor portion 4 via a second wiring portion described below.

The configuration including the above-mentioned FPC 6 may be set as the touch panel 1. Moreover, a configuration other than the configurations illustrated in FIG. 1 may be added as the configuration of the touch panel 1. For example, a glass cover provided on the first sensor portion 3 side, and a protective sheet provided on the second sensor portion 4 side may be added as configurations of the touch panel 1.

### [Regarding Units of Touch Panel]

### (Regarding Base)

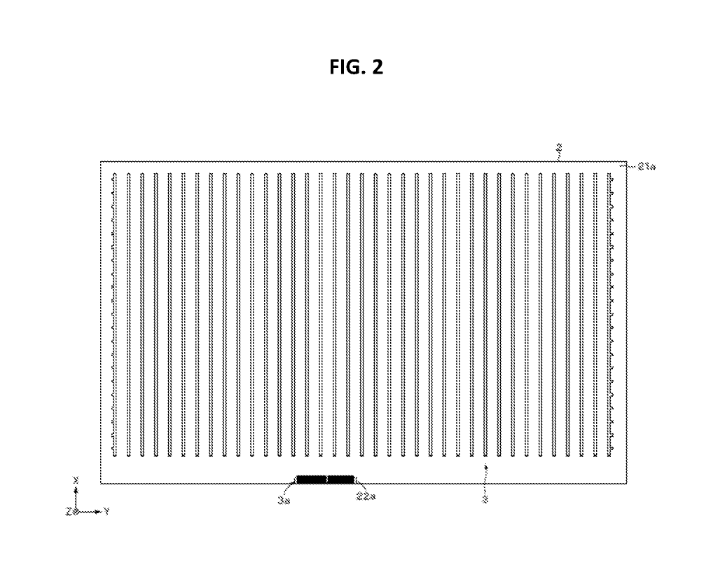

Next, each unit configuring the touch panel 1 is described with reference to FIGS. 2 to 12. Firstly, the base 2 is described. The base 2 is made of an insulating material such as glass or a film (for example, a PET (polyethylene terephthalate) film). In the embodiment, the base 2 has a rectangular shape, but may have another polygonal shape, a circular shape, or an elliptical shape. The base 2 includes the first major surface 21a (the front side), and the second major surface 21b (the back side) on a side opposite to the first major surface 21a. As described above, the first major surface 21a is provided with the first sensor portion 3, and the second major surface 21b is provided with the second sensor portion 4.

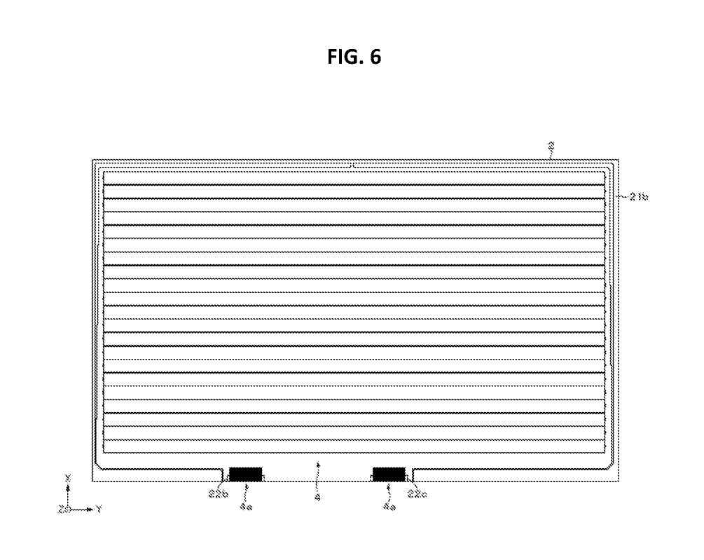

A first connection portion 22a (refer to FIG. 2) being an area to which the distal end portion 6b of the FPC 6 is connected by, for example, thermal compression is set on the first major surface 21a. A second connection portion 22b and a third connection portion 22c, which are areas to which the distal end portions 6a and 6c of the FPC 6 are connected by, for example, thermal compression, are set on the second major surface 21b (refer to FIG. 6). In the embodiment, the second connection portion 22b and the third connection portion 22c correspond to a second connection portion in the claims.

### (Regarding First Sensor Portion)

Next, the first sensor portion 3 is described. The first sensor portion 3 is a transparent conductive sensor unit, and functions as, for example, a receiving (Rx) electrode. “Transparent” in the description is simply required to be, for example, at a degree that the display contents of a display displayed via the touch panel 1 is visible. In the embodiment, the first sensor portion 3 is made of an ITO (Indium Tin Oxide) film. As illustrated in FIG. 2, for example, the first sensor portion 3 is configured in such a manner that a plurality of rectangular electrode patterns extending in the X-axis direction is provided lining up in the Y-axis direction. The first sensor portion 3 is formed by, for example, photolithography or laser etching.

### (Regarding First Conductive Portion)

As described above, the first connection portion 22a to which the FPC 6 is connected is set on the first major surface 21a. As illustrated in FIG. 2, the first connection portion 22a is provided with a first conductive portion 3a with electrical conductivity. The first conductive portion 3a is made of, for example, the same ITO film as the first sensor portion 3. The first conductive portion 3a has a comb-lobe shape toward an edge of the first major surface 21a. Although the details are described below, the first conductive portion 3a is formed together (simultaneously) with the first sensor portion 3. For example, the ITO film that has been deposited uniformly on the first major surface 21a is removed in appropriate places to enable the simultaneous formation of the first sensor portion 3 and the first conductive portion 3a. The first conductive portion 3a is formed together with the first sensor portion 3. Accordingly, the first conductive portion 3a has the same material and the same thickness as the first sensor portion 3.

### (Regarding First Wiring Portion)

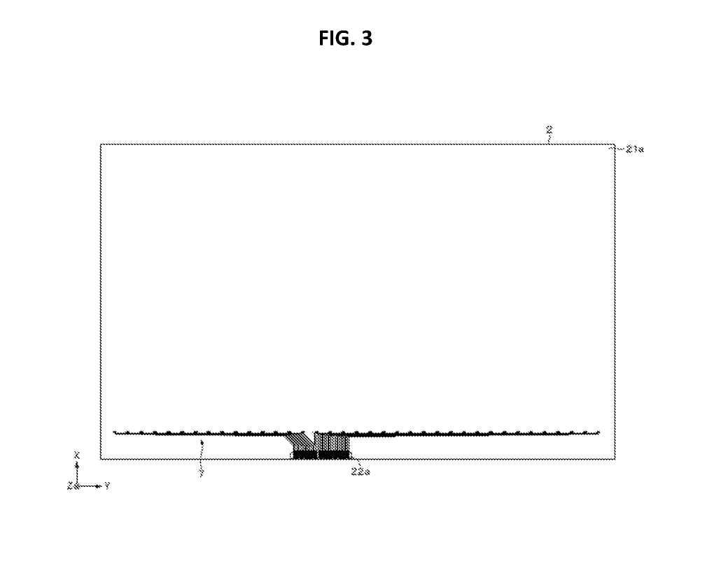

Next, the first wiring portion (a first wiring portion 7) connected to the first sensor portion 3 is described. FIG. 3 illustrates the first wiring portion 7 formed on the first major surface 21a. In the embodiment, the first wiring portion 7 includes a plurality of silver wire patterns formed by laser etching. Naturally, the first wiring portion 7 may include, for example, wire patterns of copper other than silver. The silver wire patterns of the first wiring portion 7 are connected to the undersurfaces of the electrode patterns of the first sensor portion 3, respectively. Each wire is routed toward the first connection portion 22a as illustrated in FIG. 3.

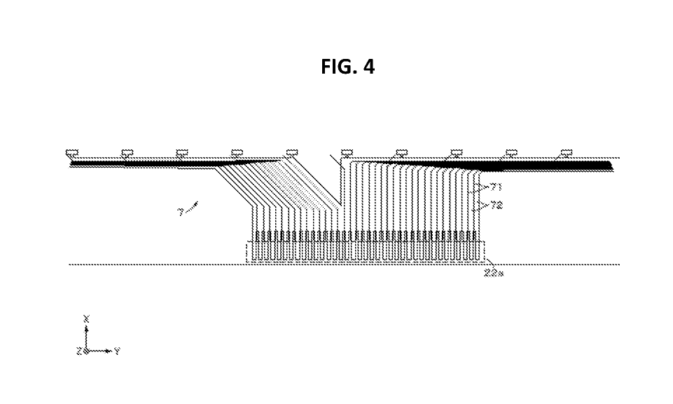

FIG. 4 is a diagram illustrating the expanded first wiring portion 7 in the vicinity of the first connection portion 22a. As described above, the first wiring portion 7 includes a plurality of silver wires 72 partitioned by a plurality of laser grooves 71 formed by laser etching. Each silver wire 72 is routed to the first connection portion 22a. In the first connection portion 22a, the first wiring portion 7 has a comb-lobe shape toward the edge of the first major surface 21a.

### (Regarding First Shielding Portion)

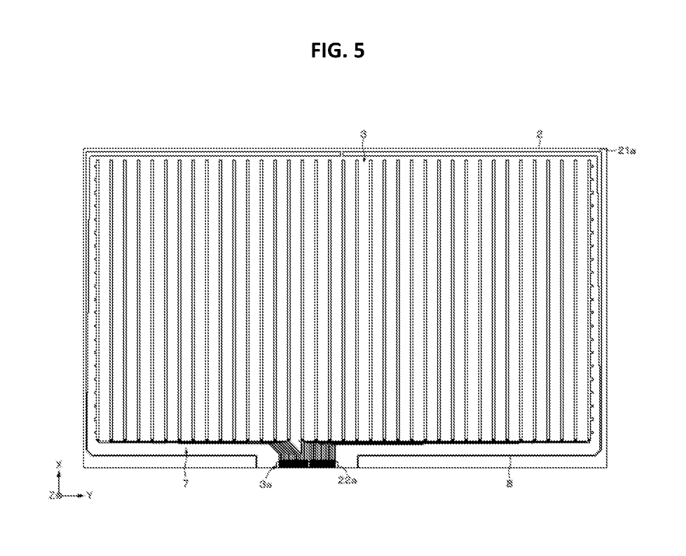

FIG. 5 is a diagram illustrating the above-mentioned base 2, first sensor portion 3, and first wiring portion 7 in combination. The first major surface 21a of the base 2 is further provided with a first shielding portion 8. The first shielding portion 8 is provided along an outer edge of the first major surface 21a in such a manner as to substantially surround the perimeter of the first sensor portion 3 and the first wiring portion 7. The first shielding portion 8 prevents the entry of static electricity. Accordingly, it is possible to prevent a reduction in the detection accuracy of the touch panel 1 and a malfunction accompanied by the reduction. The first shielding portion 8 includes a pattern of silver, copper, or the like, and is connected to ground or a predetermined ground potential. The first shielding portion 8 may include a ground pattern that is provided as appropriate to prevent the propagation of noise between the electrode patterns.

### (Regarding Second Sensor Portion)

Next, the second sensor portion 4 is described. The second sensor portion 4 is a transparent conductive sensor unit, and functions as, for example, a transmitting (Tx) electrode. In the embodiment, the second sensor portion 4 is made of an ITO film. As illustrated in FIG. 6, for example, the second sensor portion 4 is configured in such a manner that a plurality of rectangular patterns extending in the Y-axis direction is provided lining up in the X-axis direction. The second sensor portion 4 is formed by, for example, photolithography or laser etching.

### (Regarding Second Conductive Portion)

As described above, the second connection portion 22b and the third connection portion 22c, to which the FPC 6 is connected, are set on the second major surface 21b. As illustrated in FIG. 6, each of the second and third connection portions 22b and 22c is provided with a second conductive portion 4a with electrical conductivity. The second conductive portion 4a is made of, for example, the same ITO film as the second sensor portion 4. The second conductive portion 4a has a comb-lobe shape toward an edge of the second major surface 21b. Although the details are described below, the second conductive portion 4a is formed together (simultaneously) with the second sensor portion 4. For example, the ITO film that has been deposited uniformly on the second major surface 21b is removed in appropriate places to enable the simultaneous formation of the second sensor portion 4 and the second conductive portion 4a. The second conductive portion 4a is formed together with the second sensor portion 4. Accordingly, the second conductive portion 4a has the same material and the same thickness as the second sensor portion 4.

### (Regarding Second Wiring Portion)

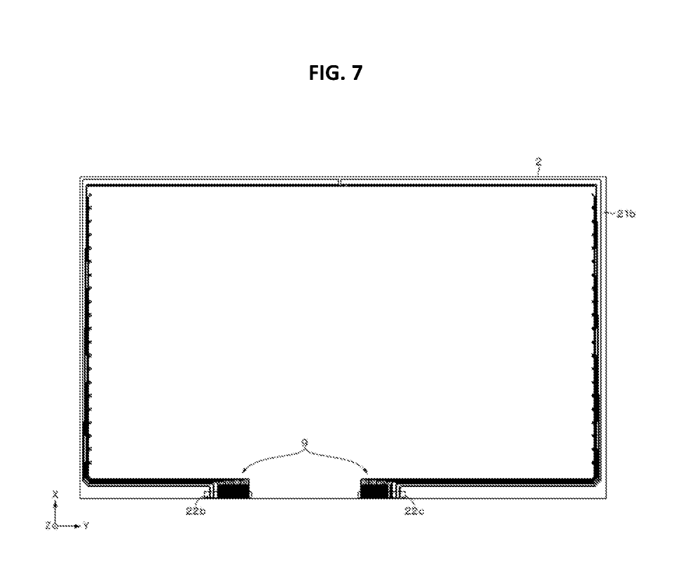

Next, the second wiring portion (a second wiring portion 9) connected to the second sensor portion 4 is described. FIG. 7 is a diagram illustrating the second wiring portion 9 formed on the second major surface 21b. In the embodiment, the second wiring portion 9 includes silver wire patterns formed by laser etching. Naturally, the second wiring portion 9 may include, for example, wire patterns of copper other than silver. The silver wire patterns of the second wiring portion 9 are connected to the electrode patterns of the second sensor portion 4 on both of the left and right sides, respectively. As illustrated in FIG. 7, each wire connected to the electrode pattern on the left side is routed toward the second connection portion 22b, and each wire connected to the electrode pattern on the right side is routed toward the third connection portion 22c.

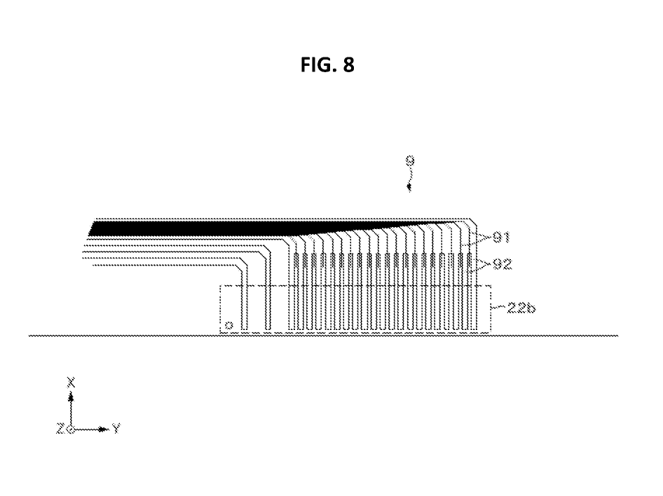

FIG. 8 is a diagram illustrating the expanded second wiring portion 9 in the vicinity of the second connection portion 22b. As described above, the second wiring portion 9 includes a plurality of silver wires 92 partitioned by a plurality of laser grooves 91 formed by laser etching. Each silver wire 92 is routed to the second connection portion 22b. In the second connection portion 22b, the second wiring portion 9 has a comb-lobe shape toward the edge of the second major surface 21b. The second wiring portion 9 in the vicinity of the third connection portion 22c also has a similar configuration except a point of being bilaterally symmetrical with FIG. 8.

### (Regarding Second Shielding Portion)

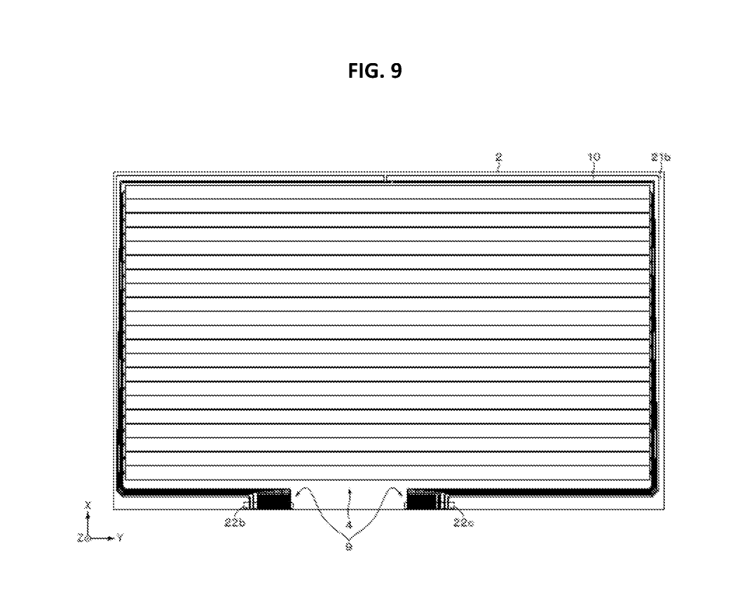

FIG. 9 is a diagram illustrating the above-mentioned base 2, second sensor portion 4, and second wiring portion 9 in combination. The second major surface 21b of the base 2 is provided with a second shielding portion 10. The second shielding portion 10 is provided along an outer edge of the second major surface 21b in such a manner as to substantially surround the perimeter of the second sensor portion 4 and the second wiring portion 9. The second shielding portion 10 prevents the entry of static electricity. Accordingly, it is possible to prevent a reduction in the detection accuracy of the touch panel 1 and a malfunction accompanied by the reduction. The second shielding portion 10 includes a pattern of silver, copper, or the like, and is connected to ground or a predetermined ground potential. The second shielding portion 10 may include a ground pattern that is provided as appropriate to prevent the propagation of noise between the electrode patterns.

### (Regarding Cross-sectional Configuration of Touch Panel)

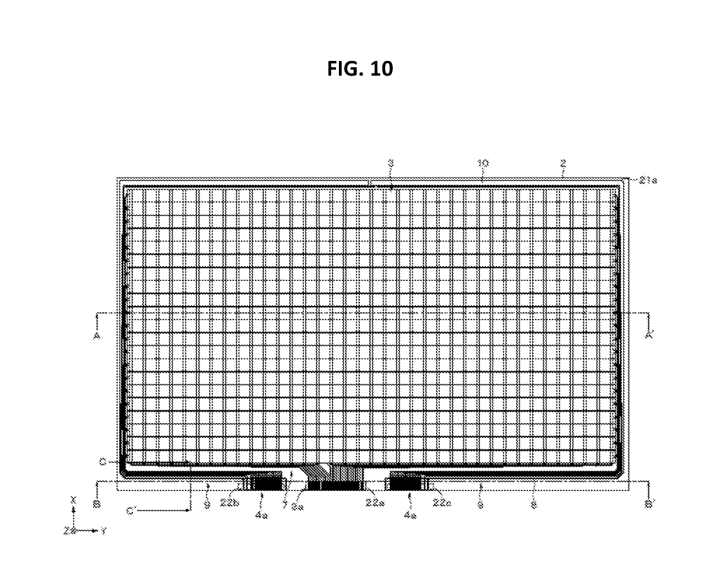

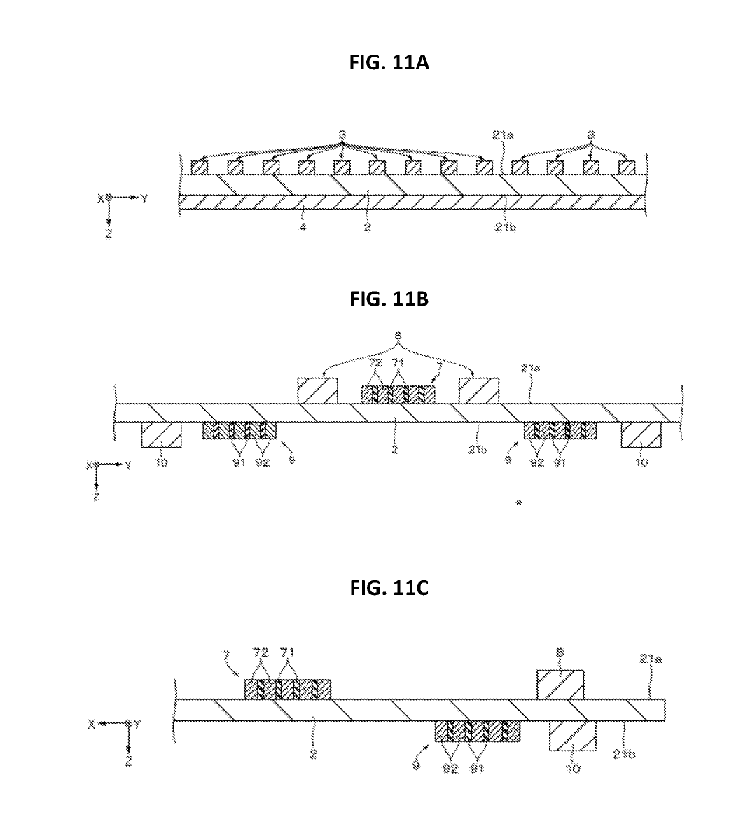

Next, a cross-sectional configuration of the touch panel 1 is described. FIG. 10 is a diagram illustrating the configuration of the above-mentioned touch panel 1 aligned (projected) on one side (for example, the first major surface 21a). FIG. 11A is a cross-sectional view in a case where the touch panel 1 has been cut along line A-A′ of FIG. 10. FIG. 11B is a cross-sectional view in a case where the touch panel 1 has been cut along line B-B′ of FIG. 10. FIG. 11C is a cross-sectional view in a case where the touch panel 1 has been cut along line C-C′ of FIG. 10.

As illustrated in FIG. 11A, the first major surface 21a of the base 2 is provided with the first sensor portion 3, and the second major surface 21b of the base 2 is provided with the second sensor portion 4.

As illustrated in FIGS. 11B and 11C, the first wiring portion 7 and the second wiring portion 9 are provided in positions that do not overlap with each other in a cross-sectional direction from the first major surface 21a to the second major surface 21b (the Z-axis direction in the embodiment), respectively. With such a configuration, for example, even if the second major surface 21b is provided with the second wiring portion 9 by laser etching, there is no possibility that a laser output that can be propagated to the first major surface 21a side via the base 2 damages the first wiring portion 7, since the first major surface 21a on the other side is not provided with the first wiring portion 7. In other words, even if the first wiring portion 7 and the second wiring portion 9 are provided by laser etching on both sides of the base 2, respectively, there is no need to adjust a laser output with high accuracy. Moreover, the use of laser etching eliminates the necessity of a large-scale facility as compared to a manufacturing method using photolithography, and allows the manufacturing cost to be reduced.

### (Regarding Example of Configuration of Connection Portion)

Next, an example of the configuration of the connection portion according to the embodiment is described. In this example, a description is given taking the second connection portion 22b as an example. However, the same applies to the third connection portion 22c.

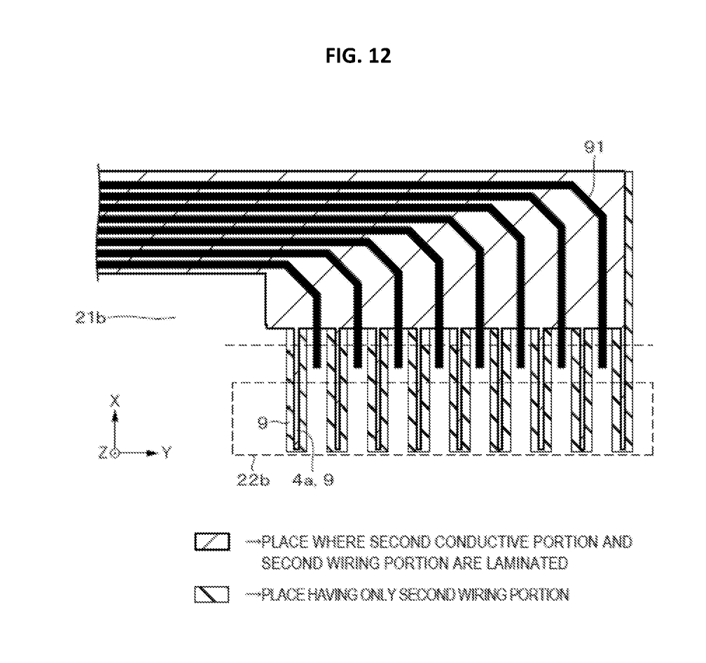

As described above, the second conductive portion 4a is formed in the second connection portion 22b, together with the second sensor portion 4. In the embodiment, the second wiring portion 9 is provided, laminated on at least the second conductive portion 4a provided to the second connection portion 22b, as illustrated in FIG. 12. The second wiring portion 9 may be provided, laminated on the second conductive portion 4a in an area other than the second connection portion 22b as illustrated in FIG. 12.

In a case of such a configuration, it is preferable that the width of the second conductive portion 4a in the second connection portion 22b (in the following description, the width indicates a length in a direction substantially orthogonal to the cross sectional direction, and a length in the Y-axis direction) is made shorter than the width of the second wiring portion 9 in the second connection portion 22b. Consequently, even if print misalignment occurs when the second wiring portion 9 is formed, a contact between the second wiring portion 9 and the adjacent second conductive portion 4a can be prevented.

Examples of numerical values are illustrated below. An aspect of the present invention is not limited to the following numerical values:

Pitch of the silver print wire (the wire of the comb-lobe shaped second wiring portion 9): 0.7 (mm)

Line width/gap of the silver print wire (the wire of the comb-lobe shaped second wiring portion 9): 0.4/0.3 (mm)

Pitch of the comb-lobe shaped pattern of the second conductive portion: 0.7 (mm)

Line width/gap of the comb-lobe shaped pattern of the second conductive portion: 0.15/0.55 (0.2/0.5 is also acceptable)

In the embodiment, the first connection portion 22a also has a similar configuration to the second connection portion 22b. For example, the first wiring portion 7 is provided, laminated on at least the first conductive portion 3a provided to the first connection portion 22a. The first wiring portion 7 may be provided, laminated on the first conductive portion 3a in an area other than the first connection portion 22a. Moreover, the width of the first conduction portion 3a is preferable to be shorter than the width of the first wiring portion 7. With such a configuration, a contact between the first wiring portion 7 and the adjacent first conductive portion 3a can be prevented even if print misalignment occurs when the first wiring portion 7 is formed.

As described above, the place where the FPC 6 is thermally compressed is caused to have a double layer structure where the configurations with electrical conductivity are laminated. Accordingly, conductive resistance can be reduced. Moreover, even if silver ink of the wire deteriorates with time, electrical conductivity can be ensured due to the existence of the first and second conductive portions 3a and 4a with electrical conductivity.

### [Regarding Method for Manufacturing Touch Panel]

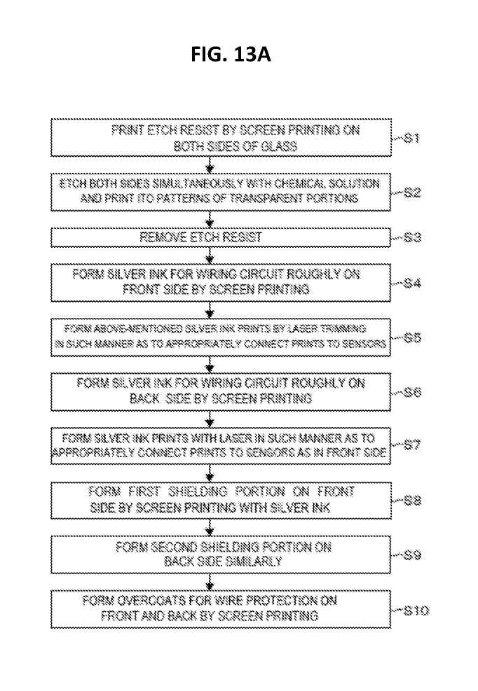

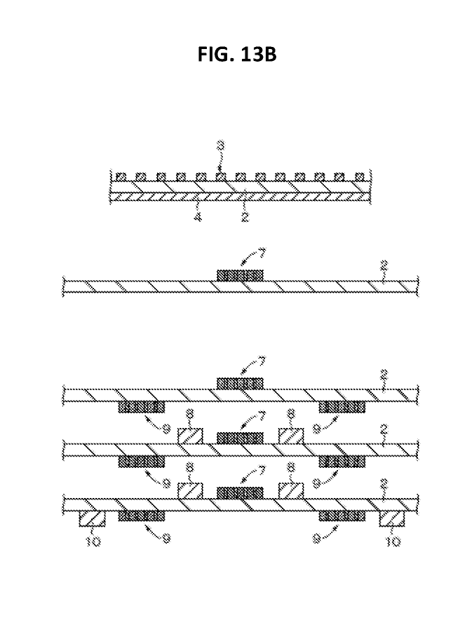

Next, an example of a method for manufacturing the touch panel 1 according to the embodiment is described with reference to FIG. 13. FIG. 13A is a flowchart (flowchart) of the method for manufacturing the touch panel 1. Moreover, FIG. 13B illustrates configurations formed in predetermined steps as appropriate to facilitate understanding.

In step S1, an etch resist is printed by screen printing on both sides of the base 2 where ITO has been deposited. In step S2 being the next step, both sides (the first and second major surfaces 21a and 21b) of the base 2 are simultaneously etched with a chemical solution to print ITO patterns. The ITO patterns in this step are patterns corresponding to the first sensor portion 3, the second sensor portion 4, the first conductive portion 3a, and the second conductive portion 4a.

In step S3 being the next step, the etch resist is removed to simultaneously form the first sensor portion 3, the second sensor portion 4, the first conductive portion 3a, and the second conductive portion 4a. In this manner, in the embodiment, ITO is left in the predetermined places of the first, second, and third connection portions 22a, 22b, and 22c without being removed. Steps S1 to S3 correspond to a first step.

In step S4 being the next step, silver ink for a wiring circuit is roughly formed by screen printing on the front side (the first major surface 21a in the embodiment). At this point in time, silver ink is also printed on the first conductive portion 3a formed in the first connection portion 22a in such a manner as to be laminated in such a comb-lobe shape as illustrated in FIG. 12.

In step S5 being the next step, the silver ink formed in step S4 is trimmed (patterned) with a laser. Wires of the silver ink partitioned by the laser grooves 71 are appropriately connected to the electrode patterns of the first sensor portion 3. Consequently, the first wiring portion 7 connected to the first sensor portion 3 is formed. Moreover, a configuration is formed in which the first conductive portion 3a and the first wiring portion 7 are laminated in at least the first connection portion 22a. Steps S4 and S5 correspond to a second step. Here, in terms of the first wiring portion 7, the first wiring portion 7 may be formed by forming an ITO pattern in an area corresponding to the first wiring portion 7 in step S1, printing silver ink on the ITO pattern and forming a laminate of the ITO pattern and the silver ink in step S4, and trimming the laminate of the ITO pattern and the silver ink with a laser at a time in step S5.

In step S6 being the next step, silver ink for a wiring circuit is roughly formed by screen printing on the back side (the second major surface 21b in the embodiment). At this point in time, silver ink is also printed on the second conductive portion 4a formed in the second connection portion 22b in such a manner as to be laminated in such a comb-lobe shape as illustrated in FIG. 12.

In step S7 being the next step, the silver ink formed in step S6 is trimmed (patterned) with a laser. Wires of the silver ink partitioned by the laser grooves 91 are appropriately connected to the electrode patterns of the second sensor portion 4. Consequently, the second wiring portion 9 connected to the second sensor portion 4 is formed. As described above, the second wiring portion 9 is provided in positions that do not overlap with the first wiring portion 7 in the cross-sectional direction. Moreover, a configuration is formed in which the second conductive portion 4a and the second wiring portion 9 are laminated in at least the second connection portion 22b. Steps S6 and S7 correspond to a third step. Here, in terms of the second wiring portion 9, the second wiring portion 9 may be formed by forming an ITO pattern in areas corresponding to the second wiring portion 9 in step S1, printing silver ink on the ITO pattern and forming a laminate of the ITO pattern and the silver ink in step S6, and trimming the laminate of the ITO pattern and the silver ink with a laser at a time in step S7.

When the second wiring portion 9 is formed by laser etching, since the first wiring portion 7 is not present in places on the side opposite to the places where the second wiring portion 9 is formed, it is possible to prevent energy of a laser that can be propagated to the places from damaging the first wiring portion 7. Therefore, when the first and second wiring portions 7 and 9 are formed on the front and back of the base 2, respectively, there is no need to adjust the output of a laser. Accordingly, an arbitrary laser output can be set, and the touch panel 1 can be efficiently manufactured.

In step S8 being the next step, the first shielding portion 8 is formed on the first major surface 21a by screen printing using silver ink. In step S9 being the next step, the second shielding portion 10 is formed on the second major surface 21b by screen printing using silver ink.

In step S10 being the next step, an overcoat for wire protection is formed by screen printing on each of the first and second major surfaces 21a and 21b. As described above, the touch panel 1 is produced. Although not illustrated, the FPC 6 is connected by, for example, thermal compression to the first and second connection portions 22a and 22b. Consequently, electrical continuity is established between the first and second sensor portions 3 and 4 and the FPC 6. Accordingly, outputs obtained by the first and second sensor portions 3 and 4 can be taken out to the outside of the touch panel 1.

### 2. Modification

Up to this point, the embodiment of an aspect of the present invention has been specifically described. However, an aspect of the present invention is not limited to the above-mentioned embodiment, and various modifications can be made.

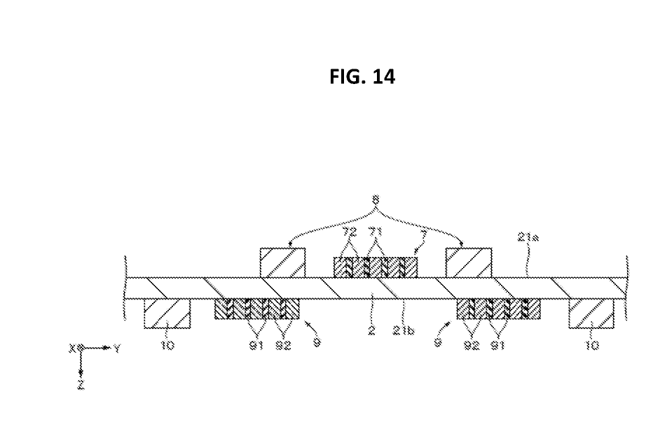

As illustrated in FIG. 14, the first shielding portion 8 may be provided on the first major surface 21a in a position where at least a part thereof overlaps with the second wiring portion 9 in the cross-sectional direction. A step of forming the first shielding portion 8 corresponds to a fourth step. When the first shielding portion 8 is formed in this manner, laser trimming is already complete in the above-mentioned second and third steps. Accordingly, laser trimming is not performed in the subsequent steps. Therefore, even if the first shielding portion 8 is provided in a position where a part thereof overlaps with the second wiring portion 9 in the cross-sectional direction, a laser does not damage the second wiring portion 9. Furthermore, each configuration can be converged. Accordingly, a reduction in the width of the edge of the touch panel 1 can be promoted.

Moreover, in a case of the configuration illustrated in FIG. 14, the thickness (the length in the cross-sectional direction) of the first and second shielding portions 8 and 10 may be increased as compared to the thickness of the first and second wiring portions 7 and 9. With such a configuration, the shielding performance (noise immunity performance) due to the first and second shielding portions 8 and 10 can be improved. Moreover, for example, when the thickness of the first shielding portion 8 is increased, even if the second wiring portion 9 is formed after the first shielding portion 8 is formed, it is possible to make it hard to have the influence of a laser upon forming the second wiring portion 9.

In the above-mentioned embodiment, the example has been described in which the first wiring portion 7 provided to the first connection portion 22a is provided in such a manner as to be laminated on the first conductive portion 3a, and the second wiring unit 9 provided to the second connection portion 22b is provided in such a manner as to be laminated on the second conductive portion 4a. However, the embodiment is not limited to this example, and may be configured in such a manner that one of the first conductive portion 3a and the second conductive portion 4a is formed. In such a configuration, the corresponding first wiring portion 7 or second wiring portion 9 may be provided, laminated on the formed conductive portion. Even with this configuration, similar effects to the embodiment can be obtained. The conductive portion corresponding to the first wiring portion 7 provided to the first connection portion 22a is the first conductive portion 3a, and the conductive portion corresponding to the second wiring portion 9 provided to the second connection portion 22b is the second conductive portion 4a.

In the above-mentioned embodiment, the first connection portion and the second connection portion may be one connection portion, or may be configured by a plurality of connection portions. Moreover, the steps according to the embodiment can be changed as appropriate. For example, the first wiring portion 7 on the first major surface 21a side may be formed after the second wiring portion 9 on the second major surface 21b side is formed. Moreover, in the above-mentioned embodiment, the example where the electrode patterns are rectangular has been described. However, the electrode patterns may be rhomboidal or the like. Moreover, in the embodiment, the description has been given taking the first major surface 21a as the front side, and the second major surface 21b as the back side. However, the front and back sides may be the other way around.

The configurations, methods, steps, shapes, materials, numerical values, and the like cited in the above-mentioned embodiment and modification are merely examples. Configurations, methods, steps, shapes, materials, numerical values, and the like that are different from them may be used if necessary, and can also be replaced with known ones. Moreover, the configurations, methods, steps, shapes, materials, numerical values, and the like in the embodiment and the modification can be combined in a scope that does not generate a technical contradiction.

### REFERENCE SIGNS LIST

2 Base
3 First sensor portion
3a First conductive portion
4 Second sensor portion
4a second conductive portion
6 FPC
7 First wiring portion
8 First shielding portion
9 Second wiring portion
21a First major surface
21b Second major surface
22a First connection portion
22b Second connection portion
22c Third connection portion
71, 91 Laser groove
72, 92 Silver wire

1. A touch panel comprising:
a base;
a first transparent conductive sensor portion provided on a first major surface of the base;
a first wiring portion connected to the first sensor portion and provided on the first major surface;
a second transparent conductive sensor portion provided on a second major surface of the base, the second major surface being on a side opposite to the first major surface; and
a second wiring portion connected to the second sensor portion and provided on the second major surface, wherein
each of the first and second wiring portions includes a plurality of wires partitioned by laser grooves, and
the first and second wiring portions are provided respectively in positions that do not overlap with each other in a cross-sectional direction from the first major surface to the second major surface.

2. The touch panel according to claim 1, wherein a shielding portion is provided on the first major surface in a position where at least a part thereof overlaps with the second wiring portion in the cross-sectional direction.

3. The touch panel according to claim 2, wherein the shielding portion is configured to be thicker in the cross-sectional direction than the first and second wiring portions.

4. The touch panel according to claim 1, wherein
a first connection portion to which a flexible printed circuit is connected is set on the first major surface,
a second connection portion to which the flexible printed circuit is connected is set on the second major surface, and
at least one of the first wiring portion provided to the first connection portion and the second wiring portion provided to the second connection portion is provided in such a manner as to be laminated on a conductive portion.

5. The touch panel according to claim 4, wherein the conductive portion has the same material and the same thickness as at least one of the first and second sensor portions, and is configured to be shorter in a width in a direction substantially orthogonal to the cross-sectional direction of the conductive portion than the wiring portion laminated on the conductive portion.

6. A method for manufacturing a touch panel, comprising:
a first step of forming a first transparent conductive sensor portion on a first major surface of a base, and forming a second transparent conductive sensor portion on a second major surface on a side opposite to the first major surface;
a second step of forming a first wiring portion connected to the first sensor portion on the first major surface by laser patterning; and
a third step of forming a second wiring portion connected to the second sensor portion on the second major surface by laser patterning, wherein
the second and third steps include forming the first and second wiring portions respectively in positions that do not overlap with each other in a cross-sectional direction from the first major surface to the second major surface.

7. The method for manufacturing a touch panel according to claim 6, further comprising a fourth step of forming a shielding portion on the first major surface in a position where at least a part thereof overlaps with the second wiring portion in the cross-sectional direction.

8. The method for manufacturing a touch panel according to claim 6, wherein
the first step includes forming a first conductive portion with electrical conductivity in a first connection portion being a place to which a flexible printed circuit is connected on the first major surface, together with the first sensor portion,
the second step includes forming a second conductive portion with electrical conductivity in a second connection portion being a place to which the flexible printed circuit is connected on the second major surface, together with the second sensor portion, and
at least one of the first wiring portion provided to the first connection portion and the second wiring portion provided to the second connection portion is formed in such a manner as to be laminated on the corresponding conductive portion.

9. An electronic device comprising the touch panel according to claim 1.

10. The touch panel according to claim 2, wherein
a first connection portion to which a flexible printed circuit is connected is set on the first major surface,
a second connection portion to which the flexible printed circuit is connected is set on the second major surface, and
at least one of the first wiring portion provided to the first connection portion and the second wiring portion provided to the second connection portion is provided in such a manner as to be laminated on a conductive portion.

11. The touch panel according to claim 10, wherein the conductive portion has the same material and the same thickness as at least one of the first and second sensor portions, and is configured to be shorter in a width in a direction substantially orthogonal to the cross-sectional direction of the conductive portion than the wiring portion laminated on the conductive portion.

12. The touch panel according to claim 3, wherein
a first connection portion to which a flexible printed circuit is connected is set on the first major surface,
a second connection portion to which the flexible printed circuit is connected is set on the second major surface, and
at least one of the first wiring portion provided to the first connection portion and the second wiring portion provided to the second connection portion is provided in such a manner as to be laminated on a conductive portion.

13. The touch panel according to claim 12, wherein the conductive portion has the same material and the same thickness as at least one of the first and second sensor portions, and is configured to be shorter in a width in a direction substantially orthogonal to the cross-sectional direction of the conductive portion than the wiring portion laminated on the conductive portion.

14. The method for manufacturing a touch panel according to claim 7, wherein
the first step includes forming a first conductive portion with electrical conductivity in a first connection portion being a place to which a flexible printed circuit is connected on the first major surface, together with the first sensor portion,
the second step includes forming a second conductive portion with electrical conductivity in a second connection portion being a place to which the flexible printed circuit is connected on the second major surface, together with the second sensor portion, and
at least one of the first wiring portion provided to the first connection portion and the second wiring portion provided to the second connection portion is formed in such a manner as to be laminated on the corresponding conductive portion.

15. The method for manufacturing a touch panel according to claim 8, wherein
the first step includes forming a first conductive portion with electrical conductivity in a first connection portion being a place to which a flexible printed circuit is connected on the first major surface, together with the first sensor portion,
the second step includes forming a second conductive portion with electrical conductivity in a second connection portion being a place to which the flexible printed circuit is connected on the second major surface, together with the second sensor portion, and
at least one of the first wiring portion provided to the first connection portion and the second wiring portion provided to the second connection portion is formed in such a manner as to be laminated on the corresponding conductive portion.

16. An electronic device comprising the touch panel according to claim 2.

17. An electronic device comprising the touch panel according to claim 3.

18. An electronic device comprising the touch panel according to claim 4.

19. An electronic device comprising the touch panel according to claim 5.
